(19) United States
(12) Patent Application Publication
(10) Pub. No.: US 2010/0043990 A1
(43) Pub. Date: Feb. 25, 2010

(54) BIOPOLYMERS AS WET STRENGTH ADDITIVES

(75) Inventors: Jan Matthijs Jetten, Zeist (NL); Harm Jan Thiewes, Woudenberg (NL); Jeffrey Wilson Thornton, Huizen (NL)

Correspondence Address: FOLEY AND LARDNER LLP;SUITE 500, 3000 K STREET NW, WASHINGTON, DC, 20007, US

(73) Assignee: NEDERLANDSE ORGANISATIE VOOR TOEGEPASTNATUURWETENS, Delft (NL)

(21) Appl. No.: 12/515,912

(22) PCT Filed: Nov. 23, 2007
(86) PCT No.: PCT/NL2007/050589

§ 371 Date: Jul. 1, 2009

(30) Foreign Application Priority Data
Nov. 23, 2006 (EP) 06124692.2

(51) Int. Cl. D21H 17/24; C08B 31/00; D21H 23/00

(52) U.S. Cl. 162/164.3; 525/54.24; 162/164.1

(57) ABSTRACT

The invention concerns the use of a combination of an anionic polysaccharide having a preferred carboxyl content of 0.2-0.4 per monosaccharide unit and an aldehyde content of less than 0.5 aldehyde group per anionic acid group, and a cationic polymer, as a wet strength additive for papermaking.

The present invention relates to the use of a combination of anionic and cationic biopolymers as temporary wet strength agents for paper and tissue applications, as well as non-wovens.

### BACKGROUND

In paper and tissue products, wet strength is an important characteristic determining the overall performance of the products. Wet strength of such products can be increased by using wet strength additives. Widely used wet strength additives for the paper industry include melamine-formaldehyde and urea-formaldehyde. There is a need, however, to move away from such oil-based chemicals, because they are not renewable and have a poor biodegradability.

WO 2001/077437 (EP-B 1282741) describes the use of fibre particles having alternate coatings of cationic and anionic polymers for imparting wet strength in paper and non-woven products. The patent illustrates PAAE (polyaminoamide epichlorohydrin) and G-PAM (glyoxylated polyacryl amide) as cationic polymers, while cationic guar, cationic starch, polyvinyl amine, and several other ones are mentioned as well. PAAE is oil-based, and therefore not a sustainable material, while migration of monomers (epichlorohydrin) causes a safety problem, which can only be solved at high cost. Carboxymethyl cellulose (CMC) having a degree of substitution of 0.78 is the anionic polymer of choice of WO 2001/077437, although anionic starch, anionic guar, polystyrene sulphonate and other ones are mentioned as well, but not illustrated. No other specific types of anionic or cationic polysaccharides than CMC are described. However, CMC is also partly dependent on oil-based materials (monochloroacetic acid) and, moreover, is a rather expensive material. Furthermore, the multilayer technique of WO 2001/077437 is a process disadvantage.

WO 2001/083887 (EP-B 1278913) discloses the use of anionic biopolymers having more than 0.75 aldehyde group per anionic group, as a wet strength agent to be combined with a cationic polymer such as PAAE. The aldehyde-containing anionic biopolymers can for instance be dialdehyde starch which is further oxidised with peracetic acid and bromide, or starch which is oxidised with nitroxides such as TEMPO under controlled conditions.

U.S. Pat. No. 6,586,588 describes selective oxidation of polysaccharides with TEMPO so as to maximise aldehyde content (aldehyde to carboxylic acid ratio of 0.5 or higher) and minimise the carboxyl content. The polysaccharides may also be amphoteric by starting from cationic substrates. The products can be used as wet strength paper additives.

WO 2005/080499 describes the use of mixtures carboxylated carbohydrates such as 6-carboxy starch with polyamines such as polyvinyl amine, as a coating or a paper product additive to provide binding strength, dry tensile strength, or thickening effects.

WO 2005/080680 describes the production of hair protein (keratin) hydrolysates and suggests their use as a wet-end additive in papermaking.

The object of the invention is to provide processes and means for imparting wet strength to paper products which are cost-effective, and at the same time avoid technical and ecological problems of monomer migration, use of oil-based chemicals or other non-sustainable raw materials, as well as toxic effects of disposed or reused waste papers.

### DESCRIPTION OF THE INVENTION

It was found that a combination of an anionic biopolymer in the presence of aldehyde and/or epoxy groups, and a cationic polymer have excellent properties as wet strength agents, and can be applied simultaneously or in single steps, thus resulting in a less complicated process.

The anionic biopolymer is preferably a carboxylated polysaccharide. Examples of polysaccharides include α-glucans having 1,3-, 1,4- and/or 1,6-linkages. Among these, the “starch family”, including amylose, amylopectin and dextrins, is especially preferred, but pullulan, elsinan, reuteran and other α-glucans, are also suitable, although the proportion of 1,6-linkages is preferably below 70%, more preferably below 60%. Other suitable polysaccharides include β-1,4-glucans (cellulose), β-1,3-glucans, xyloglucans, glucomannans, galactans and galactomannans (guar and locust bean gum), other gums including heterogeneous gums like xanthan, ghatti, carrageenans, alginates, pectin, β-2,1- and β-2,6-fructans (inulin and levan), etc.

The carboxylated polysaccharide should contain at least 0.1 carboxylic group per monosaccharide unit, up to e.g. 1.0 carboxylic group per unit. In particular, the carboxyl content is between 0.15-0.5 per unit, most preferably between 0.2 and 0.4. In addition, or less preferably instead of the carboxylic groups, other anionic groups, such as sulphate or phosphate groups may be present.

The carboxyl groups are preferably part of the polysaccharide itself, i.e. preferably uronic groups (e.g. 6-carboxy groups in polyaldohexoses, 5-carboxy groups in polyaldofuranopentoses, 2- and/or 6-carboxy groups in polyketohexoses, etc.). These uronic groups may be present as a result of natural or controlled biosynthesis, through enzymatic oxidation of hydroxymethyl groups. Natural galacturonans are examples this class. As a practically useful alternative, they may be produced by chemical or mixed chemical/enzymatic oxidation of the hydroxymethyl groups of the polysaccharide.

The selective oxidation of hydroxymethyl groups (i.e. primary hydroxyl functions) to aldehyde and/or carboxyl functions has been known for several years. Nitric oxides, i.e. nitrogen dioxide and dinitrogen tetroxide or nitrite/nitrate are known in the art as suitable oxidising agents for these oxidations, as described e.g. in U.S. Pat. No. 3,364,200 and NL 93.01172 and by Painter, Carbohydrate Research 55, 950193 (1977) and ibid. 140, 61-68 (1985). This oxidation may be performed in an apolar, e.g. halogenated, solvent, or in an aqueous solvent, such as phosphoric acid.

A preferred reagent for the selective oxidation of hydroxymethyl groups is constituted by nitroxyl compounds, such as TEMPO (2,2,6,6-tetramethyl-piperidine-N-oxide) and related compounds such as 2,2,5,5-tetramethylpyrrolidine-N-oxyl, 2,2,5,5-tetramethylimidazoline-N-oxyl, and 4-hydroxy TEMPO and derivatives thereof such as the 4-phosphonooxy, 4-acetoxy, 4-benzoyloxy, 4-oxo, 4-amino, 4-acetamino, 4-maleimido, 4-isothiocyanato, 4-cyano and 4-carboxy TEMPO. TEMPO is used in these reactions as a catalyst (e.g. using 0.1-25 mol % with respect to final oxidising agent) in the presence of a final oxidising agent such as hypochlorite or hydrogen peroxide. TEMPO oxidation has been described e.g. in WO 95/07303. Furthermore, intermediate oxidants such as transition metal complexes (see WO 00/50388), enzymes such as laccase or peroxidases (see WO 99/23240, WO 99/23117 and WO 00/50621) can be used. The aldehyde to carboxyl ratio can be controlled by selecting appropriate conditions: aldehyde formation is favoured at low temperatures (0-20° C.) and at relatively low pH (3-7) and by controlled addition and/or low levels of oxidising agent. Further details can be found in WO 00/50463, WO 01/34657 and WO 01/00681.

It is preferred that the carboxylated polysaccharide and the cationic polymer are used in the presence of a compound containing aldehyde and/or compounds containing epoxy groups. Where reference is made herein to aldehyde groups, these may be free aldehyde groups, i.e. having a free carbonyl group, but they will be more often bound aldehyde groups, especially hydroxyl-bound, i.e. in the form of hemiacetal or hemiacylal functions. The compounds containing aldehyde and/or epoxy groups may be distinct compounds such as glyoxal, glutardialdehyde, butane diepoxide etc. The amount of these compounds is preferably such that the aldehyde/epoxy content per carboxyl group or per monosaccharide unit of the carboxylated polysaccharide is as defined below, for example between 0.2 and 0.7 aldehyde and/or epoxy group per carboxyl group and/or between 0.05 and 0.3 per monosaccharide unit.

Preferably the compound containing aldehyde and/or epoxy groups is the carboxylated polysaccharide itself. Aldehyde groups can be introduced by oxidation as described herein. Alternatively, aldehyde or epoxy groups can be introduced by substitution, for example by reaction of the (carboxylated) polysaccharide with butadiene-monoepoxide or with tetrahydrophthalic acid (see WO 97/36037) or other compounds introducing alkene functions, followed by ozonolysis, resulting in aldehyde groups, or by reaction with epichlorohydrin or diepoxides, resulting in epoxy groups.

The carboxylated polysaccharides may contain, in addition to the anionic groups, other functional groups, in particular aldehyde groups and/or epoxy groups. Although the presence of aldehyde groups was found to be important, it is preferred that the aldehyde content is relatively low, i.e. less than 1 aldehyde group per carboxyl (or other anionic) group, more preferably less than 0.7, e.g. down to 0.1, most preferably between 0.2 and 0.5 aldehyde group per carboxyl group. Similarly, if epoxy groups are present, it is preferred that the epoxy content less than 1 epoxy group per carboxyl (or other anionic) group, more preferably less than 0.7, most preferably between 0.2 and 0.5 epoxy group per carboxyl group. In absolute terms, the aldehyde and/or epoxy content is preferably below 0.3 per monosaccharide unit, most preferably below 0.25, e.g. between 0.05 and 0.2 aldehyde or epoxy group per unit.

If desired, aldehyde groups can be introduced by oxidation. The preferred method is the oxidation of hydroxymethyl groups, e.g. using nitroxyl catalysts as described above, which, by choosing the appropriate reaction conditions, leads to a limited level of aldehyde groups. If necessary, the aldehyde content can be adjusted afterwards, e.g. by (borohydride or hydrogen) reduction. An alternative method of introducing low levels of aldehyde groups is oxidation using periodate of polysaccharides containing dihydroxyethylene (—CHOH—CHOH—) moieties, such as 1,4-glucans, -mannans, and -galactans and 1,2-fructans, resulting in the corresponding dialdehyde analogues. This oxidation can performed on substrates already having the desired level of anionic groups. As this method leads to ring-opening of the oxidised monosaccharide units, it is preferred to restrict this method to conversion rates up to e.g. 10% or even up to 5%, resulting in average aldehyde contents of up to 0.1 and up to 0.05 per monosaccharide unit. Introduction of aldehyde groups can also be performed starting with carboxylated polysaccharides, such as carboxymethyl starch or carboxymethyl cellulose or polysaccharides glucuronic or galacturonic acid groups, followed by TEMPO oxidation or slight periodate oxidation until the desired degree level of aldehydes is attained.

An alternative or additional method of introducing carboxyl or other anionic groups is by addition. Here, the anionic groups such as carboxyl groups or other acid groups may be introduced e.g. by carboxyalkylation, sulphatation, sulphoalkylation, phosphatation, or the like. Carboxymethylation of polysaccharides is also widely used in the art, and is commonly performed using sodium monochloroacetate in alkaline medium or by hydroxyalkylation (e.g. with ethylene oxide) followed by catalytic oxidation. Other carboxyalkylation, such as carboxyethylation, can be accomplished by base-catalysed addition of acrylamide followed by hydrolysis, or by addition of succinic or maleic or other anhydride, etc. Sulphate and sulpho groups can be introduced by reaction with sulphuric acid derivatives such as chlorosulphonic acid or with vinylsulphonic acid or taurine analogues. Phosphorylation can be achieved by reaction with phosphoric acid or its derivatives or with haloalkyl-phosphonic acids. However, it is preferred that at least part of the anionic groups in the polysaccharide, e.g. at least 0.1 group per unit, are uronic acid groups, in particular as 6-carboxy starch.

The anionic groups in the products thus obtained may be free carboxyl, sulpho or phosphono groups (acid form) or may preferably be in the salt form, e.g. with sodium, potassium, ammonium or substituted ammonium as the counter cation.

If desired for the purpose of enhancing wet strength, the anionic product can be further chemically modified. If desired, cationic groups can be introduced by reacting a part of the aldehyde groups with an amine, hydrazine, hydrazide or the like, optionally under reductive conditions, or by reacting, at some stage during the production, saccharidic hydroxyl groups with ammonium-containing reagents such as trimethyl-ammonio-alkyl halides or epoxides. These multifunctional cationic compounds may contain from 0.01 up to about 0.15 cationic groups per recurring unit, but preferably less than 0.5 cationic groups per anionic group.

The anionic carbohydrates preferably have a molecular weight of between 5,000 and 2,000,000 Da, more preferably between 20,000 and 1,000,000 Da.

According to the invention, the carboxylated polysaccharide is combined with a cationic polymer as, for example, cationic polysaccharides. Examples of cationic polymers include synthetic (oil-based) polymers, such as polyvinyl amines, polyethyleneimines, polyaminoamides and polyaminostyrene. However, there is a preference for cationic polymers which are—like the anionic polymers to be used for the invention—based on renewable materials. Thus the cationic polymer is preferably based on proteins or polysaccharides. Suitable proteins include proteins having a relatively high content of basic amino acids such as lysine, arginine and histidine, and which, moreover, can be obtained at relatively low cost. A useful protein is lysozyme. Another example is a keratin hydrolysate, as described e.g. in WO 05/080680.

The preferred cationic polymers are polysaccharide-based. The cationic groups may be either pH-dependent, such as primary, secondary or tertiary amine groups, of pH independent, such as quaternary ammonium groups or phosphonium or sulphonium groups. A suitable example of a cationic polysaccharide is cationic dialdehyde starch, i.e. a starch derivative obtained by periodate oxidation of starch, followed by conversion of all or part of the aldehyde groups to cationic groups by reaction with amine or hydrazine reagents, such as for example Girard's reagent (NH₂NHCOCH₂N⁺(CH₃)₃, betaine hydrazide). Similar cationic polymers based on other polysaccharides are also suitable. Another advantageous class of cationic polysaccharides are those obtained by reaction of the polysaccharides or hydroxyalkylated polysaccharides with reactive ammonium compounds such as oxiranyl-methyl trimethyl ammonium chloride, or 3-chloro-2-hydroxypropyl trimethyl ammonium chloride. Also polysaccharides based on aminosugar units, especially of the chitosan type, can be used in the combination of the invention. Cationic starch, containing ammonio(hydroxyl)alkyl groups are especially preferred. The degree of substitution for cationic groups is between 0.03 and 0.6, preferably between 0.06 and 0.4, most preferably between 0.1 and 0.3. The weight ratio between the carboxylated polysaccharide and the cationic polymer can be e.g. from 90:10 to 10:90, especially from 75:25 to 15:85. Such composite wet strength agents are a distinct embodiment of the invention.

The carboxylated polysaccharide, the optional compounds containing aldehyde or epoxy groups, and the cationic polymer can be combined, usually as aqueous solutions or dispersions, with cellulosic fibres in a manner known for the application of wet strength agents. The agents can be added simultaneously, or, preferably shortly after another, for example with an interval of between 5 seconds and 5 minutes. Such simultaneous or quasi simultaneous addition to the fibres is preferred over stepwise (multi-layer) addition. The amount of each agent is preferably between 0.1 and 4% by weight, especially between 0.3 and 3% by weight, with respect to the cellulosic fibre. If desired, the wet strength agents can be applied consecutively followed by drying the fibre web.

Using the combination of cationic and anionic polymers, paper, towel, tissue and paperboard product can be prepared using conventional papermaking techniques. The products have an improved wet strength, combined with maximum biodegradability.

### Examples

### Example 1

1) Pulp Preparation.

Test sheets were made with completely chlorine free bleached Kraft pulp (BSWK; Grapho Celeste, SCA Östrand, Sweden, kappa number 2.3, whiteness 89% ISO). The pulp was disintegrated in portions of 30 gram diluted in 2 litre water according to SCAN std method C18:65 (1964). Subsequently, this pulp was refined to a refining degree of SR°=20. The refined fibres were diluted to a stock suspension with a concentration of 0.5 w/v %.

2) Test Sheet Formation.

400 ml of the fibre stock suspension was filtered off under vacuum forming a wet test sheet (air dry weight of 2 grams resembling a basis weight of 60-65 g/m²). The wet test sheets obtained were dried at 94° C. for 6.5 minutes under vacuum with a Rapid Köthen sheet former. Different test sheets were made by adding cationic starch (DS: ˜0.18) and/or anionic starch solutions (6-carboxy aldehyde starch obtained from Glycanex, having degree of oxidation (carboxyl groups) of 30% according the Blumenkrantz method, and a degree of aldehydes 10% by hydroxylamine titration)) to the 400 ml of the fibre stock suspension. The following addition levels of cationic or/and anionic starch solutions were examined: 0, 5, 10, and 20 kg/ton. As a reference PAAE (polyamino-amide-epichlorohydrin) was used with an addition level of respectively: 5, 10, and 15 kg/ton.

3) Wet and Dry Strength Measurements.

After the paper sheets were conditioned at 23° C. and 50% relative moisture, strips of 15×122 mm were cut and measured on wet strength and dry strength properties. The relative wet strength is calculated as the ratio wet strength over dry strength as percents. Dry strength measurements were performed according to ISO standard 1924-2, whereas wet strength measurements were performed using ISO standard 3781 (using a Finch clamp).

4) Results: See Table 1

TABLE 1

| | Dry strength | Wet strength | Relative wet |
|---|---|---|---|
| Sample: | (N · m/g) | (N · m/g) | strength: (%) |
| Blanc | 69.8 | 0.6 | 0.9 |
| 5 kg/t PAAE | 74.4 | 7.8 | 10.4 |
| 10 kg/t PAAE | 74.0 | 8.6 | 11.6 |
| 15 kg/t PAAE | 77.7 | 10.9 | 14.0 |
| 20 kg/t cationic starch | 76.2 | 0.9 | 1.2 |
| 20 kg/t anionic starch | 71.9 | 0.6 | 0.8 |
| 5 kg/t cationic and 5 kg/t | 74.4 | 4.8 | 6.5 |
| anionic starch | | | |
| 10 kg/t cationic and 10 kg/t | 75.8 | 7.8 | 10.3 |
| anionic starch | | | |
| 20 kg/t cationic and 20 kg/t | 66.0 | 12.7 | 19.3 |
| anionic starch | | | |

### Example 2

Pulp preparation; Test sheet formation and strength measurements were carried out as described in example 1.

In an additional last step, part of the test sheets made with the combination of cationic and anion starch were examined after curing for 10 min. at 105° C. Hereby the test sheets were conditioned before and after curing at 23° C. and 50% relative moisture for one day.

The addition levels of cationic or/and anionic starch solutions used are given in the Table 2 containing the dry and wet strength results. As a reference PAAE (polyamino-amide-epichlorohydrin) was used with an addition level of 10 kg/ton.

The results are summarised in table 2.

### Example 3

Example 3 was repeated with the only difference that in the anionic starch the aldehyde groups had been reduced using sodium borohydride.

The results are given in table 2.

TABLE 2

| | | | Rel. wet |
|---|---|---|---|
| | Dry strength: | Wet strength: | strength: |
| Sample: | (N · m/g) | (N · m/g) | (%) |
| Blanc | 67.2 | 0.6 | 0.9 |
| 20 kg/t cationic starch | 72.2 | 1.0 | 1.4 |
| 20 kg/t anionic starch | 64.0 | 0.4 | 0.6 |
| 20 kg/t reduced anionic starch | 64.8 | 0.4 | 0.6 |
| 15 kg/t cationic and 15 kg/t | 78.1 | 7.7 | 9.9 |
| anionic starch | | | |
| 15 kg/t cationic and 15 kg/t | 70.6 | 0.4 | 0.6 |
| reduced anionic starch | | | |
| (example 4) | | | |
| 15 kg/t cationic and 15 kg/t | 74.9 | 6.2 | 8.3 |
| anionic starch; sheets cured | | | |
| 15 kg/t cationic and 15 kg/t | 74.1 | 0.8 | 1.1 |
| reduced anionic starch; sheets | | | |
| cured (example 4) | | | |

### Example 4

Example 3 was repeated with the difference that instead of the anionic starch, carboxymethyl cellulose sodium salt (CMC) (SIGMA; ds: ˜0.7; low viscosity) was used as the anionic reagent. The results are given in table 3.

TABLE 3

| | Dry | | |
|---|---|---|---|
| | strength: | Wet strength: | Rel. wet |
| Sample: | (N · m/g) | (N · m/g) | strength: (%) |
| Blanc | 67.2 | 0.6 | 0.9 |
| 20 kg/t cationic starch | 72.2 | 1.0 | 1.4 |
| 20 kg/t CMC | 68.9 | 0.4 | 0.6 |
| 15 kg/t cationic starch and | 83.6 | 0.5 | 0.6 |
| 15 kg/t CMC | | | |
| 15 kg/t cationic starch and | 77.7 | 0.6 | 0.8 |
| 15 kg/t CMC; sheets cured | | | |

1-13. (canceled)

14. A composition comprising:
(a) a uronic polysaccharide having
(i) a carboxyl content between 0.2 and 0.4 carboxyl groups per monosaccharide unit and
(ii) an aldehyde content of less than 0.5 aldehyde groups per anionic acid group, and
(b) a cationic polysaccharide.

15. A paper product comprising a composition comprising (a) a carboxylated polysaccharide, (b) a cationic polymer, and (c) a compound comprising aldehyde groups, epoxy groups, or both, wherein the number of aldehyde and epoxy groups in the composition is less than one aldehyde or epoxy group per carboxyl group.

16. The paper product according to claim 15, wherein the paper product is a paper towel, a paper tissue, or a paper board.

17. The paper product according to claim 15 wherein the carboxylated polysaccharide comprises at least 0.1 uronic acid groups per monosaccharide unit.

18. The paper product according to claim 15, wherein the carboxylated polysaccharide is 6-carboxy starch.

19. The paper product according to claim 15, wherein the carboxylated polysaccharide comprises a carboxyl content between 0.2 and 0.4 carboxyl groups per monosaccharide unit.

20. The paper product according to claim 15, wherein the carboxylated polysaccharide comprises aldehyde groups, epoxy groups, or both.

21. The paper product according to claim 20, wherein the carboxylated polysaccharide comprises between 0.1-0.7 aldehyde groups per carboxyl group.

22. The paper product according to claim 20, wherein carboxylated polysaccharide comprises between 0.05-0.3 aldehyde groups per monosaccharide unit.

23. The paper product according to claim 15, wherein the cationic polymer is a cationic polysaccharide.

24. The paper product according to claim 23, wherein the cationic polysaccharide is a cationic starch.

25. The paper product according to claim 23, wherein the cationic polysaccharide comprises between 0.1 and 0.3 cationic groups per monosaccharide unit.

26. The paper product according to claim 15, wherein the composition has a weight ratio of anionic polysaccharide to cationic polymer between 1:4 and 4:1.

27. A method of providing wet strength in a paper product, the method comprising incorporating into the paper product a composition comprising (a) a carboxylated polysaccharide, (b) a cationic polymer, and (c) a compound comprising aldehyde groups, epoxy groups, or both, wherein the number of aldehyde and epoxy groups in the composition is less than one aldehyde or epoxy group per carboxyl group, wherein the incorporation provides wet strength to the paper product.

28. The method according to claim 27, wherein the paper product is a paper towel, paper tissue or cardboard

29. The method according to claim 27, wherein the carboxylated polysaccharide comprises at least 0.1 uronic acid groups per monosaccharide unit.

30. The method according to claim 27, wherein the carboxylated polysaccharide is 6-carboxy starch.

31. The method according to claim 27, wherein the carboxylated polysaccharide comprises a carboxyl content between 0.2 and 0.4 carboxyl groups per monosaccharide unit.

32. The method according to claim 27, wherein the carboxylated polysaccharide comprises aldehyde groups, epoxy groups, or both.

33. The method according to claim 32, wherein the carboxylated polysaccharide comprises between 0.1-0.7 aldehyde groups per carboxyl group.

34. The method according to claim 32, wherein carboxylated polysaccharide comprises between 0.05-0.3 aldehyde groups per monosaccharide unit.

35. The method according to claim 27, wherein the cationic polymer is a cationic polysaccharide.

36. The method according to claim 35, wherein the cationic polysaccharide is a cationic starch.

37. The method according to claim 35, wherein the cationic polysaccharide contains between 0.1 and 0.3 cationic grouped per monosaccharide unit.

38. The method according to claim 27, wherein the composition has a weight ratio of anionic polysaccharide to cationic polymer between 1:4 and 4:1.
